(19) United States
(12) Patent Application Publication
(10) Pub. No.: US 2011/0047005 A1
(43) Pub. Date: Feb. 24, 2011

(54) SYSTEM AND METHOD FOR FOOT TRAFFIC ANALYSIS AND MANAGEMENT

(75) Inventor: David Scanlan, Lakewood Ranch, FL (US)

Correspondence Address: MCDERMOTT, WILL & EMERY LLP;Attn: IP Department, 227 WEST MONROE STREET, SUITE 4400, CHICAGO, IL, 60606-5096, US

(73) Assignee: PHOENIX INK CORPORATION

(21) Appl. No.: 12/745,656

(22) PCT Filed: Dec. 4, 2008
(86) PCT No.: PCT/US08/13356

§ 371 Date: Oct. 26, 2010

Related U.S. Application Data
(60) Provisional application No. 61/005,366, filed on Dec. 4, 2007.

(51) Int. Cl. G06F 17/30

(52) U.S. Cl. 705/10

(57) ABSTRACT

A system for foot traffic analysis and management includes infrared sensors for sensing the movement and direction of traffic in a designated area. The system further includes one or more radio frequency identification sensors for sensing the location of a subset of the traffic in the designated area. The system also includes a controller adapted to receive data from infrared sensors and the radio frequency identification sensors, which may be provided to a computing system as an analysis and management interface. The system may further include manual alert devices that signal the controller when manually activated.

### TECHNICAL FIELD

The disclosed embodiments relate generally to a system and method for foot traffic analysis and management. More specifically, the present subject matter relates to a system and method for analyzing and managing foot traffic in a retail environment by tracking the movement and position of customers and employees.

### BACKGROUND

Due to competition in the retail sales environment, there are increasing demands to provide high customer service and reduced payrolls. Accordingly, tools developed to improve manpower needs, sales, customer service, marketing and sales management are of great benefit.

One weakness in modern retail environments is the inability to closely monitor, track, analyze and manage the movement of customers, staff and their interactions.

Therefore, a need exists for a solution which provides a system and method for analyzing and managing the location and interaction of customers and staff.

### SUMMARY

The above and other needs are met by the disclosed embodiments which provide systems and methods for foot traffic analysis and management. The solutions provided utilize various controllers and interfaces to sense, communicate and analyze the location and interaction of customers and staff. Additionally, the solutions provided utilize various computing systems to process and manage the information acquired and transmitted within the system. In one example, infrared transmitters and receivers are used to track the position of customers within the retail environment, radio frequency identification (“RFID”) sensors are used to track staff, manual alert devices are provided for customers to request assistance from the staff, wired and wireless interfaces are provided enabling communication between the various devices, a controller is provided to operate the various system elements, a computing system is associated with the controller and one or more additional computing systems may be able to access information from the system via a server connected to the main computing system through the internet.

In one example, the disclosed embodiments solve these problems, at least in part, by utilizing a system for foot traffic analysis and management. The system includes a plurality of infrared sensors adapted to sense the movement and direction of traffic in a designated area and provide an output of the acquired data; one or more radio frequency identification sensors adapted to sense the location of a subset of the traffic in the designated area and provide an output of the acquired data; and a controller adapted to receive the output data from the plurality of infrared sensors and the one or more radio frequency identification sensors.

In another example, the disclosed embodiments solve these problems, at least in part, by utilizing a system that includes a plurality of infrared sensors adapted to sense the movement and direction of traffic in a designated area and provide an output of the acquired data; one or more radio frequency identification sensors adapted to sense the location of a subset of the traffic in the designated area and provide an output of the acquired data; one or more manual alert devices adapted to receive user input to provide output of an alert request; and a controller adapted to receive the output data from the plurality of infrared sensors, the one or more radio frequency identification sensors and the one or more manual alert devices.

In yet another example, the disclosed embodiments solve these problems, at least in part, by utilizing a system that includes a plurality of infrared sensors adapted to sense the movement and direction of traffic in a designated area and provide an output of the acquired data; one or more radio frequency identification sensors adapted to sense the location of a subset of the traffic in the designated area and provide an output of the acquired data; a controller adapted to receive the output data from the plurality of infrared sensors, the one or more radio frequency identification sensors and the one or more manual alert devices and provide an output of data; and a computing system adapted receive the output data from the controller and further adapted to provide an analysis and management interface for a system user.

The disclosed embodiments enable, inter alia, determinations of daily customer traffic; customer traffic within designated areas; peak hours of customer traffic within designated areas; automatic notification of staff of customers' location and needs; customer waiting time; staff traffic within designated areas; highest yield areas; etc. The determinations enable potential for greater sales rates, improved customer experiences, improved management accounting/accountability, greater understanding of activity within the retail environment, etc.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic of a foot traffic analysis and management system.

FIG. 2 is a schematic of another foot traffic analysis and management system having a greater number of monitored zones.

FIG. 3 is a schematic of a foot traffic analysis and management system, including wired and wireless zones.

FIG. 4 is a schematic of a remote connections that may be incorporated into the foot traffic analysis and management systems.

FIG. 5 is a schematic view of elements of the foot traffic analysis and management systems shown in FIGS. 1-4.

### DETAILED DESCRIPTION OF THE PREFERRED EMBODIMENTS

It is contemplated that the subject matter described herein may be embodied in many forms. Accordingly, the embodiments described in detail below are the presently preferred embodiments, and are not to be considered limitations.

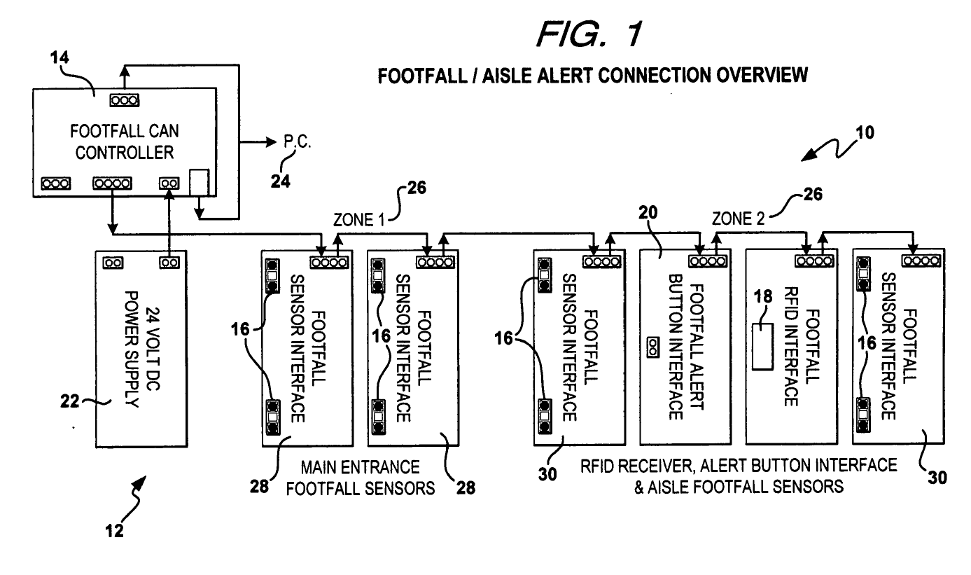

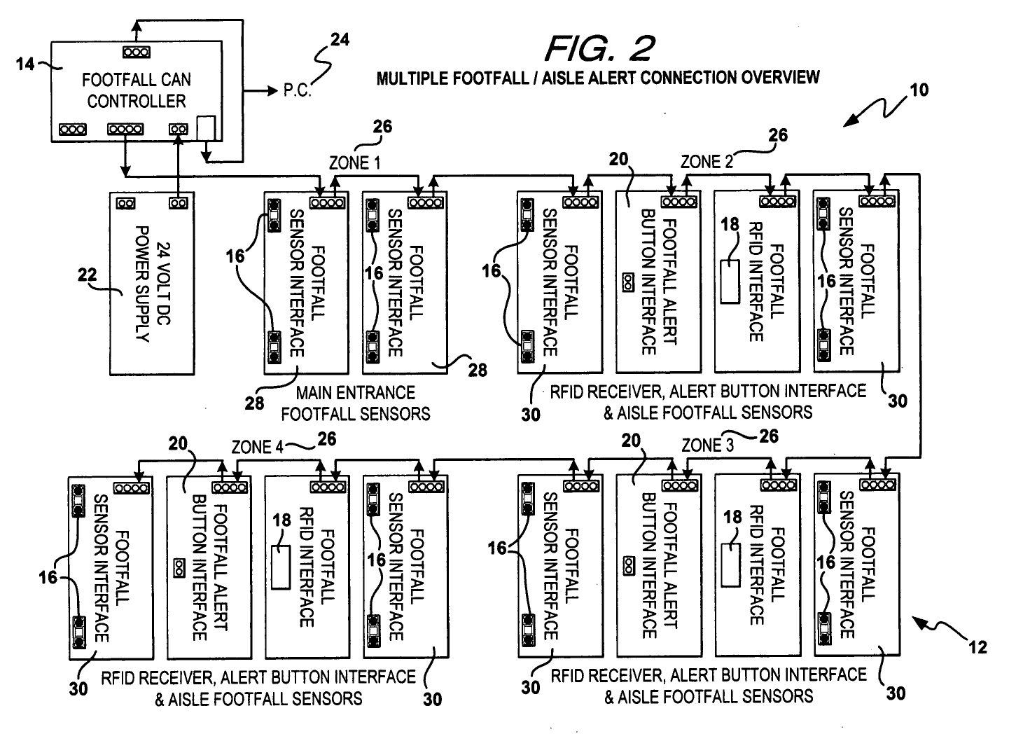

FIG. 1 illustrates a foot traffic analysis and management system 10 in which an arrangement 12 includes a controller 14 that controls a plurality of infrared sensors 16, one or more RFID sensors 18 and one or more manual alert devices 20. As further shown in FIG. 1, the arrangement 12 includes a controller power supply 22 and a computing system 24. In the example shown in FIG. 1, the arrangement 12 is a scalable system such that the number of controllers 14, sensors 16 and 18, manual alert devices 20, power supplies 22 and computing systems 24 may be greater than the numbers shown in FIG. 1. For example, FIG. 2 illustrates an arrangement 12 similar to the arrangement 12 shown in FIG. 1, but covering a greater number of zones, or designated areas 26, as described further below. However, it is understood that the arrangement 12 may be accomplished using any number of systems and devices.

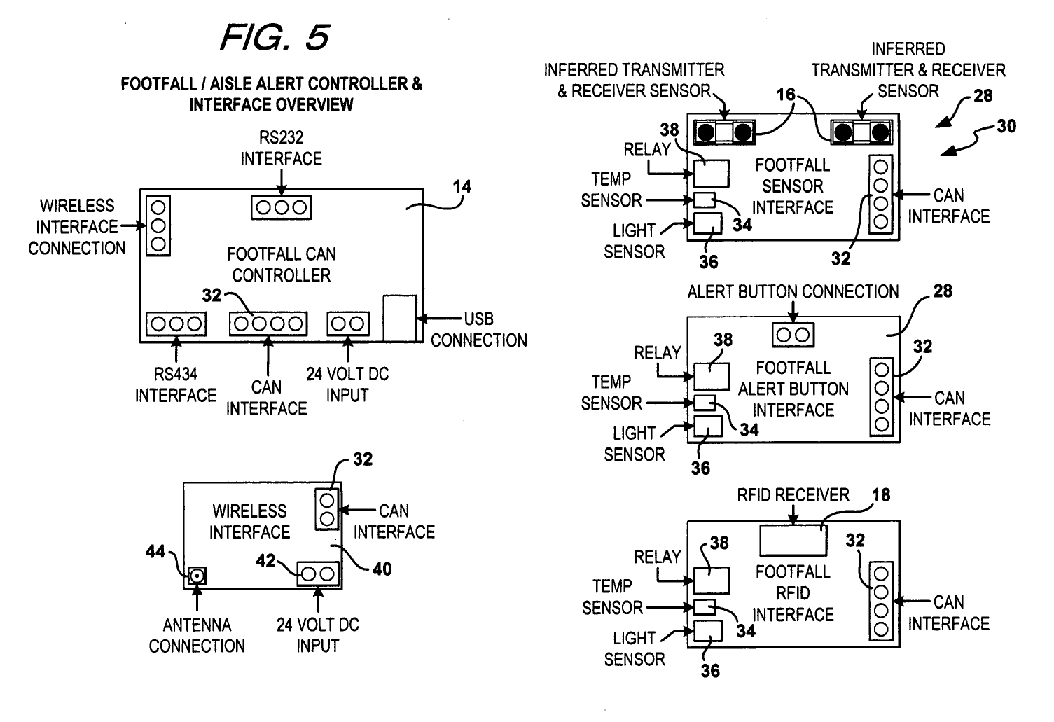

As described above, the arrangement 12 includes a controller 14. The controller 14 is described in greater detail below. However, generally and typically, the controller 14 is an integrated circuit including a central processing unit (CPU), input/output interfaces, other communication interfaces, memory, a clock generator and one or more peripherals. In the example shown in FIG. 5, the controller 14 includes interfaces for wired, wireless and USB connections, as well as a power supply input. The controller 14 is connected to and controls a closed area network (“CAN”) of devices including the sensors 16 and 18, manual alert devices 20.

As used in the examples provided herein, the controller 14 may be a hardware component, a software component or a combination of each. For example, in one example, the controller 14 may be one or more microprocessors for controlling the arrangement 12. It is contemplated that the controller 14 used to accomplish the solutions provided herein may be embodied in one or more controllers 14. Accordingly, any use of the term controller herein is understood to refer to one or more controllers 14.

The controller 14 may be embedded in the arrangement 12. In the solution shown in FIG. 1, the controller 14 may be a microcontroller, or microprocessor, embedded in a scalable computing system 24. Accordingly, the controller 14 may be responsible for managing and controlling the operation of the arrangement 12 in which it is embedded. However, in the solutions provided herein, the controller 14 is primarily responsible for foot traffic analysis and management, as will be described in further detail below.

One or more data repositories (not shown) may be embodied in one or more memory devices on the sensors 18, controller 14 or computing system 24. The data repositories may be any type of data storage devices, such as, for example, one or more databases. However, the solutions provided herein are not tied to any specific class of data storage, such as, for example, traditional relational databases.

As described above, the arrangement 12 includes a plurality of infrared sensors 16. As shown in FIG. 1, the infrared sensors 16 are embodied in main entrance footfall sensors 28 and aisle footfall sensors 30. The main entrance footfall sensors 28 and aisle footfall sensors 30 shown in FIG. 1, and in greater detail in FIG. 5 may include two infrared sensors 16 and a CAN interface 32. The CAN interface 32 also may include a temperature sensor 34, a light sensor 36 and a relay 38.

In the examples described herein, the main entrance footfall sensors 28 are located at the entrance or exit of the retail environment to count the number and direction of traffic past the main entrance footfall sensors 28. Two main entrance footfall sensors 28 are utilized to enable tracking of directional movement. However, it is understood that the main entrance footfall sensors 28 may be placed in other areas of a retail or other environment to count the number and direction of traffic past the main entrance footfall sensors 28.

In the examples described herein, the aisle footfall sensors 30 are located at the entrance or exit of a designated area 26 (such as, for example, a retail aisle) to count the number and direction of traffic past the aisle footfall sensors 30. Two aisle footfall sensors 30 are utilized, one at each end of the designated area 26, to enable tracking of movement in and out of the designated area 26. However, it is understood that the aisle footfall sensors 30 may be placed in other areas of a retail or other environment to count the number and direction of traffic into and out of one or more designated areas 26.

As described above, the arrangement 12 includes one or more RFID sensors 18. The RFID sensors 18 shown in FIG. 1, and in further detail in FIG. 5, include an RFID receiver 40 for receiving a signal from an RFID tag carried by a subset of the people being tracked, for example, the staff. The RFID sensors 18 enable the controller 14 to differentiate between sets of people, for example, customers and staff. For example, if the aisle footfall sensors 30 track a person into a designated area 26, the controller 14 may compare the information received from the aisle footfall sensors 30 to information received from the RFID sensors 18 to determine whether the person is a customer or staff member. As further shown in FIG. 5, the RFID sensors 18 may further include a CAN interface 32 with a temperature sensor 34, a light sensor 36 and a relay 38.

As described above, the arrangement 12 includes one or more manual alert devices 20. The manual alert devices 20 may include, for example, a push button switch and a CAN interface 32 with a temperature sensor 34, a light sensor 36 and a relay 38. Via the push button switch (or other manual activation mechanism), the manual alert devices 20 may allow a customer to request assistance from the staff. Accordingly, activation of the manual alert devices 20 may send a signal to the controller 14, which in turn may activate a signal to the staff relaying the request for assistance.

In the example shown in FIG. 1, the arrangement 12 of the main entrance footfall sensors 28, aisle footfall sensors 30, the RFID sensor 18, and the manual alert device 20 enables the controller 14 to monitor all of the traffic into and out of the main entrance as well as within a designated area 26. In the example shown in FIG. 2, the arrangement 12 of the main entrance footfall sensors 28, aisle footfall sensors 30, the RFID sensors 18, and the manual alert devices 20 enables the controller 14 to monitor all of the traffic into and out of the main entrance as well as within three designated areas 26. Tracking such information enables the computing system 24 to, among other things, make determinations of: daily customer traffic; customer traffic within designated areas 26; peak hours of customer traffic within designated areas 26; automatic notification of staff of customers' location and needs; customer waiting time; staff traffic within designated areas 26; highest yield areas; etc. The determinations enable potential for greater sales rates, improved customer experiences, improved management accounting/accountability, greater understanding of activity within the retail environment, etc.

For example, if the system 10 tracks a customer into a designated area 26 and does not locate a staff member within the designated area 26, the controller 14 may begin a timing function whereby after a certain predetermined period of time has elapsed, if a staff member has not entered the designated area 26 (presumably to assist the customer), the controller may cause a notification to be made to the staff to request assistance within the designated area 26. This automated customer assistance request may improve customer service by improving the timeliness of staff member response. In addition, if, for example, the assistance request made to the staff is transmitted through a headset or ear piece, the request may be a recorded message. For example, the message may be “a customer needs assistance in aisle 1.” The request may include further information, such as, for example, “a customer needs assistance in aisle 1, sell the value pack” or “a customer needs assistance in aisle 1, Brand X is on sale this week.”

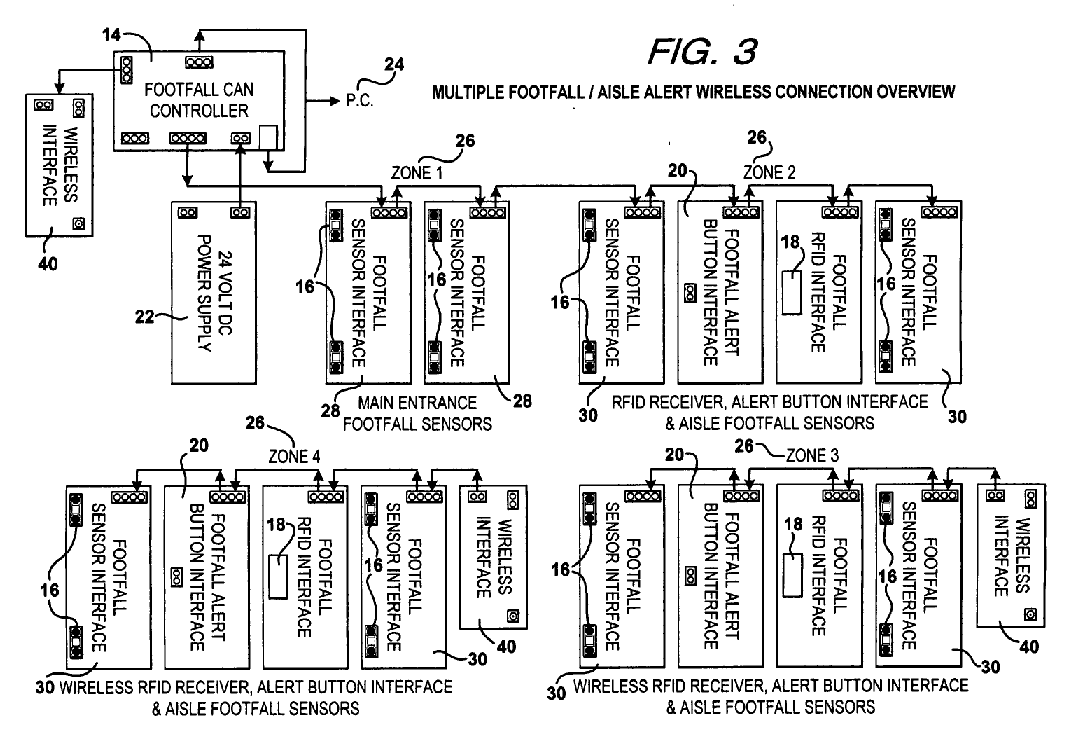

In the example shown in FIG. 3, the arrangement 12 of the main entrance footfall sensors 28, aisle footfall sensors 30, the RFID sensors 18, and the manual alert devices 20 enables the controller 14 to monitor all of the traffic into and out of the main entrance as well as within three designated areas 26, similar to that shown in FIG. 2. However, as further shown in FIG. 3, two of the designated areas 26 include wireless interfaces 40 for enabling wireless communication between the aisle footfall sensors 30, the RFID sensors 18, and the manual alert devices 20 in those designated areas 26 with the controller 14. It is understood that these wireless interfaces 40 may be utilized in connection with any of the elements of the arrangements 12 shown in FIGS. 1-3. As shown in FIG. 5, the wireless interfaces 40 may include a power supply input 42, a CAN interface 32 and an antenna connection 44.

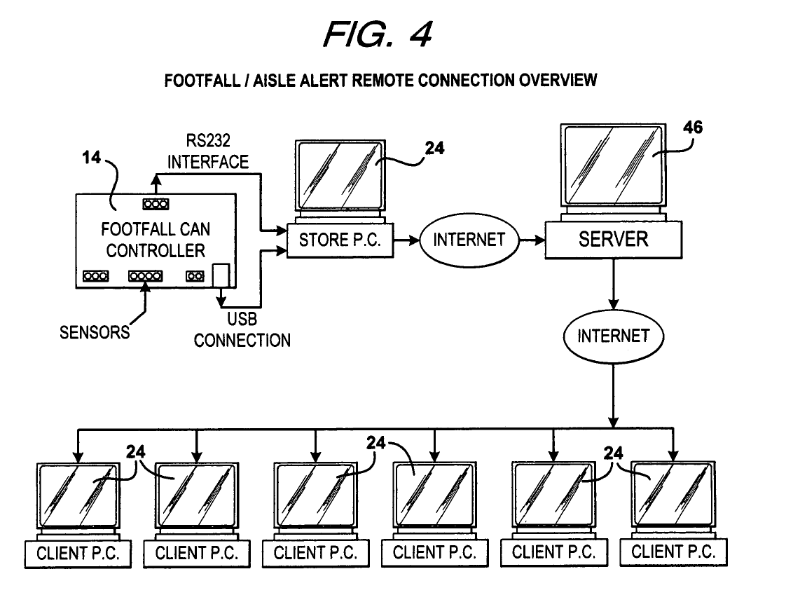

As shown in FIG. 4, the arrangements 12 shown in FIGS. 1-3 may be associated with a computing system 24 that may be further associated with a server 46 and a plurality of additional computing systems 24 to enable remote monitoring, analysis and management of the system 10. The additional computing systems 24 may be connected via a network, such as the Internet or an intranet.

As shown by the above descriptions, aspects of the systems are controlled by one or more controllers. Typically, the one or more controllers are implemented by one or more programmable data processing devices. The hardware elements operating systems and programming languages of such devices are conventional in nature, and it is presumed that those skilled in the art are adequately familiar therewith. Accordingly, any device that may be used to perform the functions described herein with respect to the controller may be substituted for the controllers described in the examples above. For example, in some instances the functions of the controller may be embodied in programmable instructions, for example, on a CD-ROM, a flash drive or any other memory.

For example, the controller may be a microprocessor in a portable arrangement, such as, for example, a cellular phone, a personal digital assistant, a audio/video playing device, etc. These systems including microprocessors are referred to generically herein as computer systems. In another example, the controller may be a PC based implementation of a central control processing system. The PC based system contains a central processing unit (CPU), memories and an interconnect bus. The CPU may contain a single microprocessor (e.g. a Pentium microprocessor), or it may contain a plurality of microprocessors for configuring the CPU as a multi-processor system. The other components of the computer system described above include memories, including a main memory, such as a dynamic random access memory (DRAM) and cache, as well as a read only memory, such as a PROM, an EPROM, a FLASH-EPROM, or the like. The system also includes mass storage devices such as various disk drives, tape drives, etc. In operation, the main memory stores at least portions of instructions for execution by the CPU and data for processing in accord with the executed instructions.

The mass storage may include one or more magnetic disk or tape drives or optical disk drives, for storing data and instructions for use by CPU. For example, at least one mass storage system in the form of a disk drive or tape drive, stores the operating system and various application software as well as data. The mass storage within the computer system may also include one or more drives for various portable media, such as a floppy disk, a compact disc read only memory (CD-ROM), or an integrated circuit non-volatile memory adapter (i.e. PC-MCIA adapter) to input and output data and code to and from the computer system.

The computer system also includes one or more input/output interfaces for communications, shown by way of example as an interface for data communications with one or more processing systems. Although not shown, one or more such interfaces may enable communications via a network, e.g., to enable sending and receiving instructions electronically. The physical communication links may be optical, wired, or wireless.

The computer system may further include appropriate input/output ports for interconnection with a display and a keyboard serving as the respective user interface for the controller. For example, the computer system may include a graphics subsystem to drive the output display. The output display, for example, may include a cathode ray tube (CRT) display, or a liquid crystal display (LCD) or other type of display device. Although not shown, a PC type system implementation typically would include a port for connection to a printer. The input control devices for such an implementation of the computer system would include the keyboard for inputting alphanumeric and other key information. The input control devices for the computer system may further include a cursor control device (not shown), such as a mouse, a touchpad, a trackball, stylus, or cursor direction keys. The links of the peripherals to the computer system may be wired connections or use wireless communications.

The computer system runs a variety of applications programs and stores data, enabling one or more interactions via the user interface provided, and/or over a network to implement the desired processing.

The components contained in the systems are those typically found in general purpose computer systems. Although illustrated as a PC type device, those skilled in the art will recognize that the class of applicable computer systems also encompasses systems used as servers, workstations, network terminals, and the like. In fact, these components are intended to represent a broad category of such computer components that are well known in the art.

A software or program product may take the form of code or executable instructions for causing a computer or other programmable equipment to perform the relevant data processing steps, where the code or instructions are carried by or otherwise embodied in a medium readable by a computer or other machine. Instructions or code for implementing such operations may be in the form of computer instruction in any form (e.g., source code, object code, interpreted code, etc.) stored in or carried by any readable medium.

Terms relating to computer or machine “readable medium” that may embody programming refer to any medium that participates in providing code or instructions to a processor for execution. Such a medium may take many forms, including but not limited to non-volatile media, volatile media, and transmission media. Non-volatile media include, for example, optical or magnetic disks, such as any of the storage devices in the computer system. Volatile media include dynamic memory, such as main memory. Transmission media include coaxial cables; copper wire and fiber optics including the wires that comprise a bus within a computer system. Transmission media can also take the form of electric or electromagnetic signals, or acoustic or light waves such as those generated during radio frequency or infrared data communications. In addition to storing programming in one or more data processing elements, various forms of computer readable media may be involved in carrying one or more sequences of one or more instructions to a processor for execution, for example, to install appropriate software in a system intended to serve as the controller 14.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A system for foot traffic analysis and management comprising:
a plurality of infrared sensors adapted to sense the movement and direction of traffic in a designated area and provide an output of the acquired data;
one or more radio frequency identification sensors adapted to sense the location of a subset of the traffic in the designated area and provide an output of the acquired data; and
a controller adapted to receive the output data from the plurality of infrared sensors and the one or more radio frequency identification sensors.

2. The system of claim 1, wherein the controller is adapted to generate output data based on the data received from at least one of the plurality of infrared sensors and the one or more radio frequency identification sensors.

3. The system of claim 2 wherein the output data from the controller includes data relating to customer traffic.

4. The system of claim 2 wherein the output data from the controller includes data relating to customer wait time.

5. The system of claim 2 wherein the output data from the controller includes data relating to staff traffic.

6. The system of claim 1 wherein the controller is adapted to receive the output data from at least one of the plurality of infrared sensors and the one or more radio frequency identification sensors, via a wireless communications link.

7. A system for foot traffic analysis and management comprising:
a plurality of infrared sensors adapted to sense the movement and direction of traffic in a designated area and provide an output of the acquired data;
one or more radio frequency identification sensors adapted to sense the location of a subset of the traffic in the designated area and provide an output of the acquired data;
one or more manual alert devices adapted to receive user input to provide output of an alert request; and
a controller adapted to receive the output data from the plurality of infrared sensors, the one or more radio frequency identification sensors and the one or more manual alert devices.

8. The system of claim 7, wherein the controller is adapted to generate output data based on the data received from at least one of the plurality of infrared sensors and the one or more radio frequency identification sensors.

9. The system of claim 8 wherein the output data from the controller includes data relating to customer traffic.

10. The system of claim 8 wherein the output data from the controller includes data relating to a notification of customer needs.

11. The system of claim 8 wherein the output data from the controller includes data relating to customer wait time.

12. The system of claim 8 wherein the output data from the controller includes data relating to staff traffic.

13. The system of claim 7 wherein the controller is adapted to receive the output data from at least one of the plurality of infrared sensors, the one or more radio frequency identification sensors and the one or more manual alert devices, via a wireless communications link.

14. A system for foot traffic analysis and management comprising:
a plurality of infrared sensors adapted to sense the movement and direction of traffic in a designated area and provide an output of the acquired data;
one or more radio frequency identification sensors adapted to sense the location of a subset of the traffic in the designated area and provide an output of the acquired data;
a controller adapted to receive the output data from the plurality of infrared sensors, the one or more radio frequency identification sensors and the one or more manual alert devices and provide an output of data; and
a computing system adapted receive the output data from the controller and further adapted to provide an analysis and management interface for a system user.

15. The system of claim 14 wherein the output data from the controller includes data relating to customer traffic.

16. The system of claim 14 wherein the output data from the controller includes data relating to a notification of customer needs.

17. The system of claim 14 wherein the output data from the controller includes data relating to customer wait time.

18. The system of claim 14 wherein the output data from the controller includes data relating to staff traffic.

19. The system of claim 14 wherein the controller is adapted to receive the output data from at least one of the plurality of infrared sensors, the one or more radio frequency identification sensors and the one or more manual alert devices, via a wireless communications link.
